(19) United States
(12) Patent Application Publication
(10) Pub. No.: US 2006/0232548 A1
(43) Pub. Date: Oct. 19, 2006

(54) Grayscale generation method for electrophoretic display panel

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/568,646

(22) PCT Filed: Aug. 10, 2004
(86) PCT No.: PCT/IB04/51436

§ 371 Date: Feb. 16, 2006

(30) Foreign Application Priority Data
Aug. 22, 2003 (EP) 03103213.9

(51) Int. Cl. G09G 3/34

(52) U.S. Cl. 345/107

(57) ABSTRACT

The electrophoretic display panel (1) for displaying a picture has a plurality of picture elements (2) and drive means (100). Each picture element (2) has two electrodes (3,4) for receiving a potential difference and charged particles (6) being able to occupy positions between the electrodes (3,4). The drive means (100) are able to supply a sequence of potential difference pulses to each picture element (2). Each sequence has a response-changing pulse for changing the ability of the particles (6) to respond to the potential difference without substantially changing the position of the particles (6), and a picture pulse for bringing the particles (6) into one of the positions for displaying the picture. For the display panel (1) to be able to display a picture of relatively high picture quality, even when the frame period is relatively large and the number of potential difference values for the picture pulse is relatively low, with respect to at least a number of the picture elements (2), the drive means (100) are further able to supply for each picture element (2) out of said number a part of the picture pulse before an end of the response-changing pulse.

The invention relates to an electrophoretic display panel for displaying a picture comprising
a plurality of picture elements, each picture element comprising two electrodes for receiving a potential difference and charged particles being able to occupy positions between the electrodes, and
drive means being able to supply a sequence of potential difference pulses to each picture element, each sequence comprising
   a response-changing pulse for changing the ability of the particles to respond to the potential difference without substantially changing the position of the particles, and
   a picture pulse for bringing the particles into one of the positions for displaying the picture.

An embodiment of the electrophoretic display panel of the type mentioned in the opening paragraph is described in non-prepublished European Patent application 02077017.8.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries. The picture elements have, during the display of the picture, appearances determined by the positions of the charged particles between the electrodes.

In the described electrophoretic display panel each response-changing pulse is a shaking pulse which increases the ability of the particles to respond to the potential difference without substantially changing the position of the particles. An example of such a shaking pulse is a pulse of 15 Volts followed by a pulse of −15 Volts, both pulses applied for 10 ms. During the application of the shaking pulse the position of the particles can change. However, as a result of the shaking pulse the position of the particles is substantially unchanged. Subsequently, the picture pulse brings the particles into one of the positions for displaying the picture. By selecting the duration and potential difference value of the picture pulse, a large number of different appearances of the picture elements can be achieved. However, normally this freedom in selecting the duration and the potential difference value of the picture pulse is not present, as normally the picture pulse consists of several sub-picture pulses, each sub-picture pulse being applied for one frame period, which usually lasts about 10 milliseconds, and each sub-picture pulse having a value being chosen from a limited number of predetermined potential difference values, e.g. −15, 0, 15 Volts. As a result only a relatively low number of appearances of the picture elements can be achieved and therefore the picture quality is relatively low.

It is a drawback of the described display panel that it is difficult to obtain therewith a relatively high picture quality when the frame period is relatively large and the number of potential difference values for the picture pulse is relatively low.

It is an object of the invention to provide a display panel of the kind mentioned in the opening paragraph which is able to display a picture of relatively high picture quality, even when the frame period is relatively large and the number of potential difference values for the picture pulse is relatively low.

The object is thereby achieved that with respect to at least a number of the picture elements, the drive means are further able to supply for each picture element out of said number a part of the picture pulse before an end of the response-changing pulse.

The invention is based on the insight that, as the response-changing pulse changes the ability of the particles to respond to the potential difference without substantially changing the position of the particles, the change in appearance of the picture element resulting from the sequence depends on the relative order of at least part of the response-changing pulse and at least part of the picture pulse in the sequence. By choosing different relative orderings of at least part of the response-changing pulse and at least part of the picture pulse in the sequence, denoted as mixing the response-changing pulse and the picture pulse, a relatively large number of appearances of the picture elements can be achieved, even when the frame period is relatively large and the number of potential difference values for the picture pulse is relatively low. In an embodiment the picture pulse is distributed around the response-changing pulse. It is favorable, if the drive means are further able to supply for each picture element out of said number a further response-changing pulse before the part of the picture pulse. Then the picture pulse is divided into at least two parts and at least two response-changing pulses are present. As a result a relatively very large number of appearances of the picture elements can be achieved.

In an embodiment the response-changing pulse is a response-increasing pulse for increasing the ability of the particles to respond to the potential difference without substantially changing the position of the particles. Then the image update time is decreased. In a variation on the embodiment the response-increasing pulse is a shaking pulse, the shaking pulse being a sequence of preset potential differences having preset values and associated preset durations, the preset values in the sequence alternating in sign, each preset potential difference representing a preset energy sufficient to release particles present in one of extreme positions, the extreme positions being positions near the electrodes, from their position but insufficient to enable said particles to reach the other one of the extreme positions. As an example consider a picture pulse consisting of two sub-picture pulses, each sub-picture pulse being applied for one frame period. The successive application of the shaking pulse, the first sub-picture pulse and the second sub-picture pulse, this ordering being the ordering present in the display panel of the said patent application, results in a relatively large change in appearance of the picture element. The successive application of the first sub-picture pulse, the shaking pulse and the second sub-picture pulse results in a relatively small change in appearance of the picture element. If, furthermore, each sequence of preset potential differences has an even number of preset potential differences, the DC component of the shaking pulse is decreased.

In an embodiment the drive means are further able to supply for each picture element out of said number the picture pulse to comprise a sequence of sub-picture pulses, each sub-picture pulse having a sub-picture value and an associated sub-picture duration, each sub-picture duration being equal to a predetermined constant. The predetermined constant is equal to the frame period. If, furthermore, the sub-picture pulses in the sequence have equal polarity, the relatively large number of appearances of the picture elements can be achieved by mixing the shaking pulse and the picture pulse. However, if the drive means are further able to supply for each picture element out of said number the sequence of the sub-picture pulses to comprise at least one positive polarity and at least one negative polarity, the relative ordering of the sub-picture pulses in the sequence can be used to achieve an even larger number of appearances of the picture elements.

It is favorable, if the drive means are further able to supply for each picture element out of said number a reset pulse prior to both the response-changing pulse and the picture pulse, the reset pulse being able to bring the particles into one of the extreme positions, the reset pulse representing an energy being at least as large as a reference energy representing an energy to change the position of particles from their present position to one of the extreme positions. Then, the dependency of the positions of the particles on a history of the potential difference pulses is reduced, and the picture update is more accurate. It is preferred if, furthermore, the energy of each reset pulse is substantially larger than the reference energy. Then the picture update is even more accurate. Such reset pulses are described in the non-prepublished European Patent application 03100133.2, also referred to as PHNL030091. It is also preferred if each reset pulse is able to bring the particles into the extreme position which is closest to the position of the particles for displaying the picture. Then an observer perceives a relatively smooth transition from an estimate of the picture to the picture. It is furthermore preferred if the drive means are further able to supply for each picture element out of said number a further shaking pulse prior to the reset pulse. As a consequence of the further shaking pulse the picture update is even more accurate.

In another embodiment, the response-changing pulses are synchronized in time.

In another embodiment, the display panel is an active matrix display panel.

It is favorable, if, in each aforementioned embodiment, each picture element is one of the number of the picture elements.

In an embodiment the display panel is part of a display device.

These and other aspects of the display panel of the invention will be additional elucidated and described with reference to the drawings, in which:

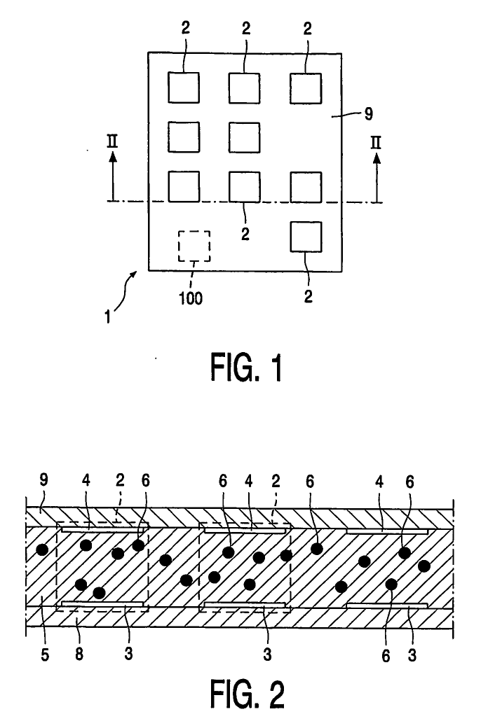

FIG. 1 shows diagrammatically a front view of an embodiment of the display panel;

FIG. 2 shows diagrammatically a cross-sectional view along II-II in FIG. 1;

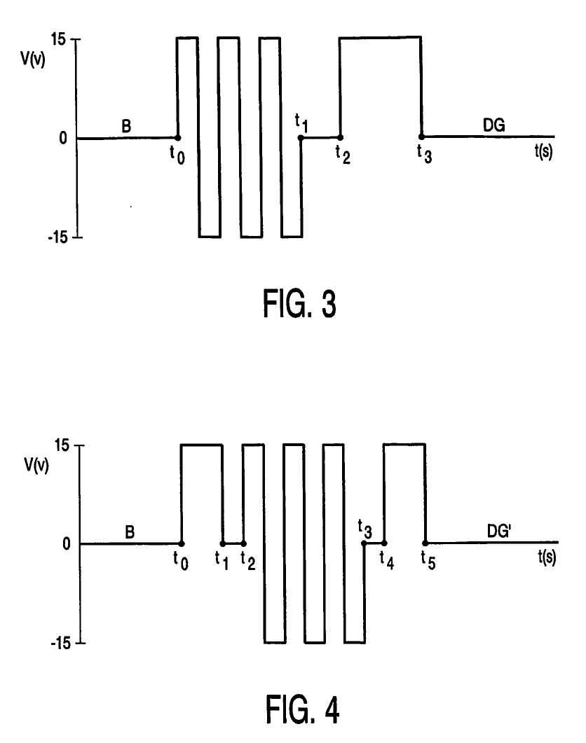

FIG. 3 shows diagrammatically the sequence of potential difference pulses as a function of time for a picture element of the display panel of the said patent application;

FIG. 4 shows diagrammatically the sequence of potential difference pulses as a function of time for a picture element out of said number of picture elements in the embodiment;

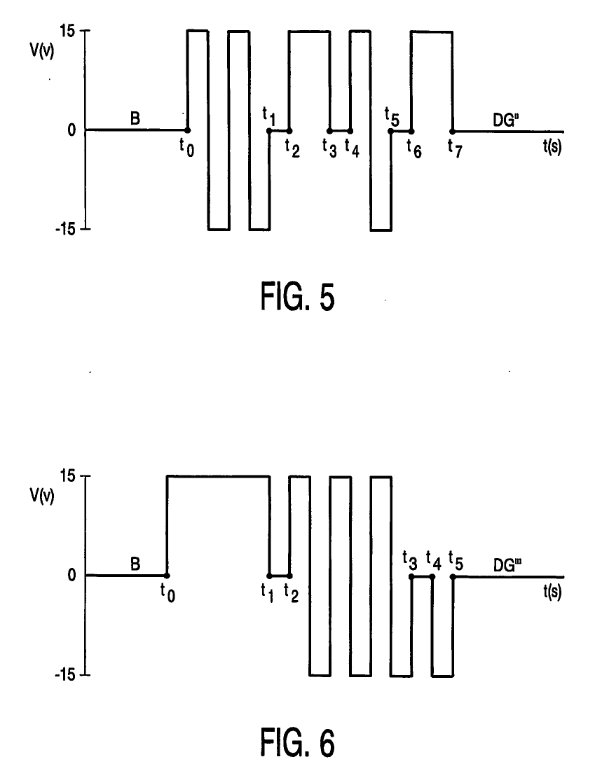

FIG. 5 shows diagrammatically the sequence of potential difference pulses as a function of time for a picture element out of said number of picture elements in another embodiment;

FIG. 6 shows diagrammatically the sequence of potential difference pulses as a function of time for a picture element out of said number of picture elements in another embodiment, and

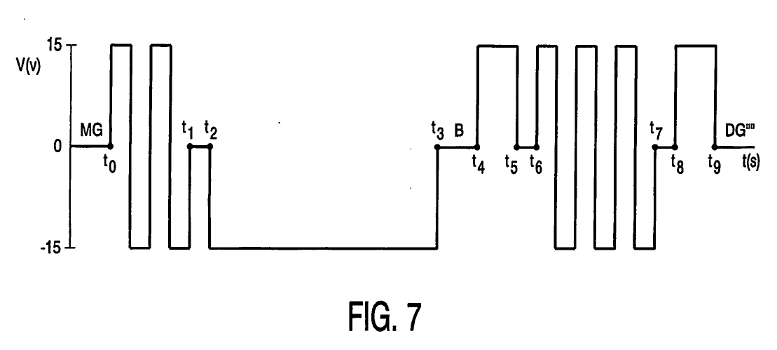

FIG. 7 shows diagrammatically the sequence of potential difference pulses as a function of time for a picture element out of said number of picture elements in another embodiment.

In all the Figures corresponding parts are referenced to by the same reference numerals.

FIGS. 1 and 2 show an example of the display panel 1 having a first substrate 8, a second transparent opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. In an active matrix embodiment, the picture elements 2 may further comprise switching electronics, for example, thin film transistors (TFTs), diodes, MIM devices or the like.

An electrophoretic medium 5, having charged particles 6 in a fluid, is present between the substrates 8,9. A first and a second electrode 3,4 are associated with each picture element 2 for receiving a potential difference. In FIG. 2 the first substrate 8 has for each picture element 2 a first electrode 3, and the second substrate 9 has for each picture element 2 a second electrode 4. The charged particles 6 are able to occupy a position being one of extreme positions near the electrodes 3,4 and intermediate positions in between the electrodes 3,4. Each picture element 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are able to supply a sequence of potential difference pulses to each picture element 2. Each sequence comprises a response-changing pulse for changing the ability of the particles 6 to respond to the potential difference without substantially changing the position of the particles 6, and a picture pulse for bringing the particles 6 into one of the positions for displaying the picture. Furthermore, with respect to at least a number of the picture elements 2, the drive means 100 are able to supply for each picture element 2 out of said number at least part of the picture pulse before an end of the response-changing pulse.

In an embodiment the response-changing pulse is a shaking pulse, which is a response-increasing pulse. The shaking pulse is a sequence of preset potential differences having preset values and associated preset durations. The preset values in the sequence alternate in sign and each preset potential difference represents a preset energy sufficient to release particles 6 present in one of extreme positions from their position but insufficient to enable said particles 6 to reach the other one of the extreme positions. As an example consider a shaking pulse having six preset potential differences and a picture pulse having four sub-picture pulses. The sequence of potential difference pulses of a picture element 2 of the display panel of the said patent application is shown as a function of time in FIG. 3. Before the application of the sequence, the appearance of the picture element 2 is e.g. black, denoted by B. The shaking pulse is e.g. a sequence of six preset potential differences, subsequently having preset values 15 Volts, −15 Volts, 15 Volts, 15 Volts, 15 Volts and −15 Volts, and being applied from time t0 to time t1. Each preset value is e.g. applied for one frame period, in this example being 10 ms. As a result of the shaking pulse the ability of the particles to respond to the potential difference is increased and the position of the particles 6 is substantially unchanged. Successively, the picture pulse is present from time t2 to time t3 having four sub-picture values, each value being 15 Volts and each associated duration being equal to one frame period. As a result the appearance of the picture element 2 is dark gray, denoted by DG. The time interval between t1 and t2 is small, it may even be zero. This successive application of the shaking pulse and the picture pulse, this ordering being the ordering present in the display panel of the said patent application, results in a relatively large change in appearance of the picture element 2.

In an example of the embodiment of the invention, the sequence of potential difference pulses of a picture element 2 out of said number is shown as a function of time in FIG. 4. Again the shaking pulse has six preset potential differences and the picture pulse has four sub-picture pulses. Before the application of the sequence, the appearance of the picture element 2 is e.g. black, denoted by B. The first part of the picture pulse is present from time t0 to time t1 and has two sub-picture values, each value being 15 Volts and each associated duration being equal to one frame period. The change in appearance as a result of the first part of the picture pulse is relatively small compared to the change in appearance as a result of the first two sub-picture values of the picture pulse of the picture element 2 of FIG. 3, as for the picture element 2 of FIG. 3 the shaking pulse has already increased the ability of the particles 6 to respond to the potential difference. Successively, the shaking pulse has six preset potential differences, subsequently having preset values 15 Volts, −15 Volts, 15 Volts, −15 Volts, 15 Volts and −15 Volts, is applied from time t2 to time t3. Again each preset value is applied for one frame period. The time interval between t1 and t2 is small, it may even be zero. Successively, the second part of the picture pulse is present from time t4 to time t5 having two sub-picture values, each value being 15 Volts and each associated duration being equal to one frame period. As a result the appearance of the picture element 2 is somewhat darker gray, denoted by DG′, than the picture element of FIG. 3, as the successive application of the first part of the picture pulse, the shaking pulse and the second part of the picture pulse results in a relatively small change in appearance of the picture element 2. The time interval between t3 and t4 is small, it may even be zero. Furthermore, the shaking pulse having six preset potential differences is an example of a shaking pulse having an even number of preset potential differences.

In another embodiment the drive means 100 are further able to supply for each picture element 2 out of said number a further response-changing pulse before the part of the picture pulse. In an example, the sequence of potential difference pulses of a picture element 2 out of said number is shown as a function of time in FIG. 5. The further shaking pulse has e.g. four preset potential differences, the shaking pulse has e.g. two preset potential differences and the picture pulse has e.g. four sub-picture pulses. Before the application of the sequence, the appearance of the picture element 2 is e.g. black. The further shaking pulse is e.g. a sequence of four preset potential differences, subsequently having preset values 15 Volts, −15 Volts, 15 Volts and −15 Volts, which is applied from time t0 to time t1. Again each preset value is applied for one frame period. Successively, the first part of the picture pulse is present from time t2 to time t3 and has two sub-picture values, each value being 15 Volts and each associated duration being equal to one frame period. The time interval between t1 and t2 is small, it may even be zero. Successively, the shaking pulse, being a sequence of two preset potential differences, subsequently having preset values of 15 Volts and −15 Volts, is applied from time t4 to time t5. Again each preset value is applied for one frame period. The time interval between t3 and t4 is small, it may even be zero. Successively, the second part of the picture pulse is present from time t6 to time t7 having two sub-picture values, each value being 15 Volts and each associated duration being equal to one frame period. As a result the appearance of the picture element 2 is about dark gray, denoted by DG″, between DG and DG′. This can be seen as follows. The change in appearance of the picture element 2 of FIG. 3 is relatively large because a relatively large shaking pulse, having 6 preset potential differences, is applied before the application of the picture pulse, resulting in a relatively large increase in the ability of the particles 6 to respond to the potential difference. The change in appearance of the picture element 2 of FIG. 5 is relatively medium because the further shaking pulse, having 4 preset potential differences, being a relatively medium shaking pulse compared to the relatively large shaking pulse of FIG. 3, is applied before the application of the first part of the picture pulse, resulting in a relatively medium increase in the ability of the particles 6 to respond to the potential difference, before the application of the first part of the picture pulse. The change in appearance of the picture element 2 of FIG. 4 is relatively small because the first part of the picture pulse is applied before the application of the shaking pulse, having 6 preset potential differences. Therefore the change in appearance of the picture element 2 due the first part of picture pulse is relatively small.

In another embodiment the drive means 100 are further able to supply for each picture element 2 out of said number the sequence of the sub-picture pulses to comprise at least one positive polarity and at least one negative polarity. In an example the sequence of potential difference pulses of a picture element 2 out of said number is shown as a function of time in FIG. 6. The shaking pulse has six preset potential differences. The picture pulse has six sub-picture pulses. Before the application of the sequence, the appearance of the picture element 2 is e.g. black. The first part of the picture pulse is present from time t0 to time t1 and has five sub-picture values, each value being 15 Volts and each associated duration being equal to one frame period. Successively, the shaking pulse, being a sequence of six preset potential differences, subsequently having preset values 15 Volts, −15 Volts, 15 Volts, −15 Volts, 15 Volts and −15 Volts, is applied from time t2 to time t3. Again each preset value is applied for one frame period. The time interval between t1 and t2 is small, it may even be zero. Successively, the second part of the picture pulse is present from time t4 to time t5 having one sub-picture value being −15 Volts and having an associated duration of one frame period. As a result the appearance of the picture element 2, denoted by DG′″ is somewhat different from the previous dark gray levels DG, DG′ and DG″. The time interval between t3 and t4 is small, it may even be zero.

In another embodiment the drive means 100 are further able to supply for each picture element 2 out of said number a reset pulse prior to both the response-changing pulse and the picture pulse. The reset pulse is able to bring the particles 6 into one of the extreme positions, the reset pulse representing an energy being at least as large as a reference energy representing an energy to change the position of particles 6 from their present position to one of the extreme positions. It is preferred if the energy of each reset pulse is substantially larger than the reference energy. Furthermore, each reset pulse is able to bring the particles 6 into the extreme position which is closest to the position of the particles 6 for displaying the picture. Furthermore, the drive means 100 are further able to supply for each picture element 2 out of said number a further shaking pulse prior to the reset pulse. In an example, the sequence of potential difference pulses of a picture element 2 out of said number is shown as a function of time in FIG. 7. The shaking pulse has six preset potential differences and the picture pulse has four sub-picture pulses. Before the application of the sequence, the appearance of the picture element 2 is e.g. middle gray, denoted by MG. The further shaking pulse is a sequence of four preset potential differences, subsequently having preset values 15 Volts, −15 Volts, 15 Volts and −15 Volts, and is applied from time to t0 time t1. Each preset value is applied for one frame period. Successively, the reset pulse is present from time t2 to time t3 having a value of e.g. −15 Volts and an associated duration being equal to e.g. thirty frame periods. As a result the appearance of the picture element 2 is black, as the energy of the reset pulse is substantially larger than the reference energy. The time interval between t1 and t2 is small, it may even be zero. Successively, the first part of the picture pulse is present from time t4 to time t5 and has two sub-picture values, each value being 15 Volts and each associated duration being equal to one frame period. Successively, the shaking pulse, being a sequence of six preset potential differences, subsequently having preset values 15 Volts, −15 Volts, 15 Volts, −15 Volts, 15 Volts and −15 Volts, is applied from time t6 to time t7. Again each preset value is applied for one frame period. The time interval between t5 and t6 is small, it may even be zero. Successively, the second part of the picture pulse is present from time t8 to time t9 having two sub-picture values, each value being 15 Volts and each associated duration being equal to one frame period. As a result the appearance of the picture element 2 is about dark gray, denoted by DG″″. The time interval between t7 and t8 is small, it may even be zero.

In another embodiment the response-changing pulses are synchronized in time, hardware shaking.

1. An electrophoretic display panel for displaying a picture comprising
a plurality of picture elements, each picture element comprising two electrodes for receiving a potential difference and charged particles being able to occupy positions between the electrodes, and
drive means being able to supply a sequence of potential difference pulses to each picture element, each sequence comprising
a response-changing pulse for changing the ability of the particles to respond to the potential difference without substantially changing the position of the particles, and
a picture pulse for bringing the particles into one of the positions for displaying the picture,
characterized in that,
with respect to at least a number of the picture elements, the drive means are further able to supply for each picture element out of said number a part of the picture pulse before an end of the response-changing pulse.

2. A display panel as claimed in claim 1 characterized in that the drive means are further able to supply for each picture element out of said number a further response-changing pulse before the part of the picture pulse.

3. A display panel as claimed in claim 1 characterized in that the response-changing pulse is a response-increasing pulse for increasing the ability of the particles to respond to the potential difference without substantially changing the position of the particles.

4. A display panel as claimed in claim 3 characterized in that the response-increasing pulse is a shaking pulse, the shaking pulse being a sequence of preset potential differences having preset values and associated preset durations, the preset values in the sequence alternating in sign, each preset potential difference representing a preset energy sufficient to release particles present in one of extreme positions, the extreme positions being positions near the electrodes, from their position but insufficient to enable said particles to reach the other one of the extreme positions.

5. A display panel as claimed in claim 4 characterized in that each sequence of preset potential differences has an even number of preset potential differences.

6. A display panel as claimed in claim 1 characterized in that the drive means are further able to supply for each picture element out of said number the picture pulse to comprise a sequence of sub-picture pulses, each sub-picture pulse having a sub-picture value and an associated sub-picture duration, each sub-picture duration being equal to a predetermined constant.

7. A display panel as claimed in claim 6 characterized in that the drive means are further able to supply for each picture element out of said number the sequence of the sub-picture pulses to comprise at least one positive polarity and at least one negative polarity.

8. A display panel as claimed in claim 1 characterized in that the drive means are further able to supply for each picture element out of said number a reset pulse prior to both the response-changing pulse and the picture pulse, the reset pulse being able to bring the particles into one of the extreme positions, the reset pulse representing an energy being at least as large as a reference energy representing an energy to change the position of particles from their present position to one of the extreme positions.

9. A display panel as claimed in claim 8 characterized in that the energy of each reset pulse is substantially larger than the reference energy.

10. A display panel as claimed in claim 8 characterized in that each reset pulse is able to bring the particles into the extreme position which is closest to the position of the particles for displaying the picture.

11. A display panel as claimed in claim 1 characterized in that each picture element is one of the number of the picture elements.

12. A display device comprising the display panel as claimed in claim 1.
